(19) United States
(12) Patent Application Publication
(10) Pub. No.: US 2009/0144028 A1
(43) Pub. Date: Jun. 4, 2009

(54) METHOD AND APPARATUS OF COMBINING MIXED RESOLUTION DATABASES AND MIXED RADIO FREQUENCY PROPAGATION TECHNIQUES

(75) Inventors: CELESTINO CORRAL, OCALA, FL (US); ALEXANDER BIJAMOV, PLANTATION, FL (US); SALVADOR SIBECAS, LAKE WORTH, FL (US); GLAFKOS STRATIS, LAKE WORTH, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/948,686

(22) Filed: Nov. 30, 2007

(51) Int. Cl. G06G 7/62; G06F 17/50

(52) U.S. Cl. 703/1; 703/13

(57) ABSTRACT

A method (10 or 500) and system (200) for simulating and improving accuracy of empirical propagation models for radio frequency coverage can include a display (210) and a processor (202) coupled to the display. The processor can be operable to input (502 and 504) low-resolution data and high-resolution data, select (506) an area of interest being simulated for empirical propagation models, and classify (508) receivers as belonging to a predetermined type of object. If a receiver in the area of interest is a low resolution object, then normal losses can be applied (510). If a receiver in the area of interest is a high resolution object, then losses specific to the high resolution object can be applied (512). If a receiver is classified as being inside a building, then the processor can further compute (516) a median power for a location of the receiver and add in-building penetration losses.

### FIELD

This invention relates generally to wireless network deployment or simulations, and more particularly to a combination of deterministic and empirical methods or simulations adaptively using mixed resolution databases.

### BACKGROUND

Current trends in wireless technology require that a propagation tool perform indoor and outdoor or mixed resolution analyses. In the past, either empirical computations or deterministic computations were used. In some other cases, radio frequency (RF) tools had different computation engines that would combine results to provide incorrect information. The incorrect information resulted from computations being done independently from two separate engines (or processors) as opposed to a single engine. In today's wireless simulation requirements, high resolution simulation for certain sub regions is imperative. It is extremely expensive and computationally intensive to have an entire city or an entire country with high resolution three dimensional (3-D) databases and run a 3-D deterministic approach.

Furthermore, the understanding of the impact of propagation effects on wireless system performance is extremely important due to the high data rates being deployed in next generation solutions. As systems are deployed over larger areas for emerging markets, it becomes impractical to measure all locations for coverage or, worse still, to determine applicable diversity schemes for improved signal reception. The problem is compounded by this type of situation: To understand the system's performance it must be deployed, but if there is no knowledge of the environment, the deployment may not be optimal.

In lieu of actual measurement, emerging solutions emphasize simulation. An existing option is to employ empirical computations which constitute a system of formulas that encompass a wide range of parameters. These parameters include base station and mobile antenna heights, frequency of operation, and type of region in which the system is to be deployed (urban, suburban, etc.). The empirical nature results from a curve fit to data obtained from measurement campaigns, and the results can be further modified by statistical variations about the median calculated from such an approach. The statistical variations can emerge from the type of environment and well-known propagation effects. For example, power distributions in high scattering environments can be modeled via log-normal and Rayleigh distributions. In addition, it is possible to incorporate penetration losses due to objects in the environment such as foliage, vehicles and buildings.

As wireless systems are deployed to meet ever-increasing demand for data, ranges are typically reduced, requiring options not conceived in original macro-cellular systems. With the advent of wireless local and metropolitan area networks (WLAN and WMAN), ranges are reduced requiring more specific knowledge of the environment. Even though more specific data might be available today in the form of high resolution maps, such specific data is not currently utilized effectively by today's simulation tools to provide optimized propagation models.

### SUMMARY

Embodiments in accordance with the present invention can provide a method and system for improving the accuracy and speed of RF predictions by combining empirical models and deterministic models using mixed resolution data. Embodiments herein can use mixed resolution data bases (for example, high resolution 3-D data, mixed with low resolution cluttered data) where computations can be done in a sequential and adaptive manner within the same engine and not independently from two different engines. Note, however, this technique can be done in parallel in the context of co-channel interference analysis (or other applications) using multiprocessing capabilities and in this regard can be considered simultaneous. Using mixed resolution databases avoids or diminishes the problems relating to computational time and overly expensive 3-D databases, while limiting the use of 3-D computational databases to areas specifically benefiting from such analysis and otherwise using low resolution databases for the remaining larger areas. These simulation techniques can be used, for example, to determine when to hand off a call between an outdoor WAN (wide area network) and an indoor wireless local area network (WLAN) based on the received power. Another example can analyze or compute co-channel interference between a WAN and indoor WLAN system which uses mixed resolution databases.

In a first embodiment of the present invention, a method of improving accuracy of empirical propagation models for radio frequency coverage simulations can include the steps of selecting an area of interest being simulated for empirical propagation models and classifying receivers in the area of interest as belonging to a predetermined type of object. If the receiver in the area of interest is a low resolution object, then normal losses are applied to the receiver and if the receiver in the area of interest is a high resolution object, then losses specific to the high resolution object are applied. The method can further include the step of determining an object type for the high resolution object and then applying losses specific to the object type for the high resolution object. If the receiver in the area of interest is classified as being inside a building, then the method can further compute a median power for a location of the receiver and add in-building penetration losses. The method can also include the steps of loading low resolution data or high resolution data or mixed resolution (e.g., both 3-D building data (high resolution) and clutter data (low resolution)). The high resolution data can include 3-dimensional locations represented in the high resolution data. The method can further include the step of identifying the 3-dimensional object locations and classifying the receivers within the 3-dimensional object locations with a predetermined object type. A low-resolution object can correlate to an image of low-resolution clutter data and a high-resolution object can correlate to an image of a high-resolution building superimposed on the low-resolution clutter data. Additionally, the method can further compute penetration losses for vehicles and foliage regions if identifiable from the high-resolution data.

In a second embodiment of the present invention, a computer program embodied in a computer storage medium and operable in a data processing system for improving accuracy of empirical propagation models for radio frequency coverage simulations, including instructions executable by the data processing system for selecting an area of interest being simulated for empirical propagation models and classifying receivers in the area of interest as belonging to a predetermined type of object. If the receiver in the area of interest is a low resolution object, then normal losses are applied to the receiver and if the receiver in the area of interest is a high resolution object, then losses specific to the high resolution object are applied. The data processing system can further be operable to function as otherwise previously described with the first embodiment described above.

In a third embodiment of the present invention, a system for simulating and improving accuracy of empirical propagation models for radio frequency coverage can include a display and a processor coupled to the display. The processor can be operable to input low-resolution data and high-resolution data, select an area of interest being simulated for empirical propagation models, and classify receivers in the area of interest as belonging to a predetermined type of object. If a receiver in the area of interest is a low resolution object, then normal losses to the receiver can be applied. If a receiver in the area of interest is a high resolution object, then losses specific to the high resolution object can be applied. If a receiver in the area of interest is classified as being inside a building, then the processor can further compute the power for a location of the receiver and add in-building penetration losses. The high-resolution data can have 3-dimensional object locations represented in the high resolution data, where the processor is further operable to identify the 3-dimensional object locations and classify the receivers within the 3-dimensional object locations with a predetermined object type.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “low resolution” as used herein can mean any resolution data that is less than higher resolution data and “higher resolution” data can mean any resolution that is higher than the low resolution data in a relative sense. For example, clutter data commonly used for large rural areas and suburban areas would be considered lower resolution data in contrast to the higher resolution data that is typically found in maps for urban areas using Google Maps for example. A “desired area” would be an area of interest to the user generally and can indicate an area including buildings or other objects, but is not necessarily limited in this regard. An “object” can be a building, a tree, a vehicle or any other object that affects a radiation pattern or polarization. An “empirical propagation model” can mean a propagation model using an empirical mathematical formulation or experimental data for characterizing radio wave propagation as a function of frequency, distance and other conditions. A model is usually developed to predict the behavior of propagation for all similar links under similar constraints. Such models typically predict the path loss along a link or the effective coverage area of a transmitter. “Loses specific to a high resolution object” can mean loses that can be applied to a known object based on knowledge that can be implied or inferred to a higher degree of accuracy than from a low resolution object. For example, knowing the height or facet angles or type of materials or even the type of object itself associated with a building or other object that is a high resolution object can be used to more accurately apply a path loss due to such additional information. “In-building penetration losses” generally refers to losses in power or signal strength (estimated or measured or empirically determined) due to such signals traversing “in-building” or through a building.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart of a method of improving the accuracy of propagation models in accordance with an embodiment of the present invention.

FIG. 2 is an illustration high resolution 3-dimensional data being superimposed on low-resolution clutter data.

FIG. 3 is a plot or image illustrating a resulting RF coverage for a receiver region in accordance with an embodiment of the present invention.

FIG. 4 is a wireless device that can be deployed in an area being simulated in accordance with an embodiment of the present invention.

FIG. 5 is flow chart illustrating a method to enhance the accuracy of a ray launching simulation tool for simulations in a mixed environment by using low-resolution and high-resolution data in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of ways using a variety of methods that can be integrated with signal bounce ray tools used for near real world radio frequency (RF) simulations. In this disclosure, we consider the ability to improve the accuracy of empirical model results using 3-D data for penetration losses in relation to wireless simulations. The simulation of RF propagation is by nature computationally intensive and any improvements in the time to render information to the user are desired, but the techniques to reduce the computational intensity are not obvious.

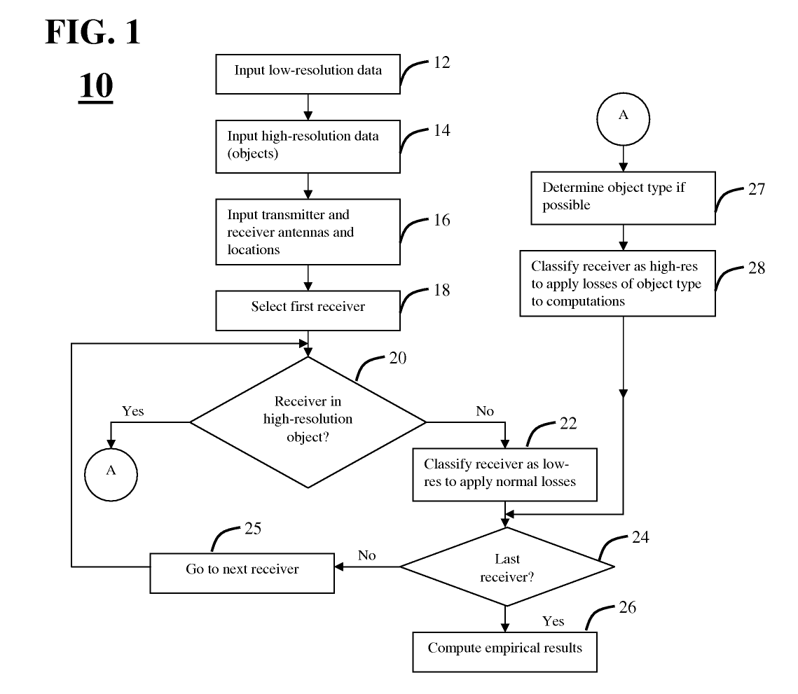

Referring to the flow chart and method 10 of FIG. 1, an embodiment herein can input low-resolution data at step 12 and high-resolution data or objects at step 14. Further information and parameters that relate to transmitter and receiver antennas and their respective locations can be loaded at step 16. Next, a first receiver is selected for analysis at step 18. Embodiments herein take the area of interest being simulated through an empirical process and classify receivers in that area as either belonging to a type of object or not. Part of the process can determine if the object is a high resolution object or not at decision block 20. If the object is not a high-resolution object and otherwise characterized as a low-resolution object, then the method 10 can apply a normal loss to the object corresponding to the location of the receiver at step 22. A determination is made if additional receivers are to be classified at decision step 24. If the last receiver is classified at decision step 24, then the empirical results are computed at step 26. Otherwise, the next receiver is queued for analysis or classification at step 25.

If the receiver is in a high-resolution object at decision step 20, then a more specific determination of the object can be made at decision step 27 if possible. If the receiver is classified as being in a high resolution area, predetermined losses applicable to the type of object type can be computed at step 28 before determining once more whether other receivers need to be analyzed in the empirical process at decision step 24. More specifically in a particular embodiment, if a receiver is classified as being inside a building (where the receiver is in a high-resolution object), then when the empirical engine computes the median power for that point, it will also add in-building penetration losses. In this way, that receiver point is accurately capturing the appropriate losses and is not a random point in a given area. The method can take advantage of 3-D data if available to the computational engine. For example, if the region has low-resolution data but a certain portion of the region has high-resolution data that represents 3-D object locations, the approach can include the steps of identifying those particular 3-D areas and classifying the receivers as belonging to a certain object type. Using this object type allows the empirical computation engine to implement the appropriate penetration losses specific to that object, thereby improving the accuracy of the simulation results for that area.

Motorola, Inc. of Schaumburg, Ill. has developed a wireless radio wave propagation software tool named MotoWavez™. The core of the tool is a 3-D ray tracer which computes ray propagation paths from the base station transmitter antennas to the receivers. Recently, MotoWavez implemented an empirical computation engine that works with Motorola's NetPlan clutter data in order to provide quick computation of coverage and data rate based on a modified Hata model. MotoWavez with the implementations described herein will now also support “mixed-mode” simulations where it is possible to use both low-resolution clutter data and high-resolution 3-D data simultaneously and apply the appropriate computation engine for each region in an adaptive manner. For example, assuming that the computation starts from an empirical region and then enters a deterministic region, the tool can then dynamically switch to deterministic computations from the empirical methods or vice versa. Another example is when a receiver is in the deterministic region inside a building and computing the co-channel interference with a transmitter located in the low resolution region is desired. The unique situation here is that the longitude and latitude location of the point or region of interest in the deterministic environment can be identified, then such information can be used as a reference point for the empirical computation and then the computations (both deterministic and empirical computations) can be combined for computing the co-channel interference.

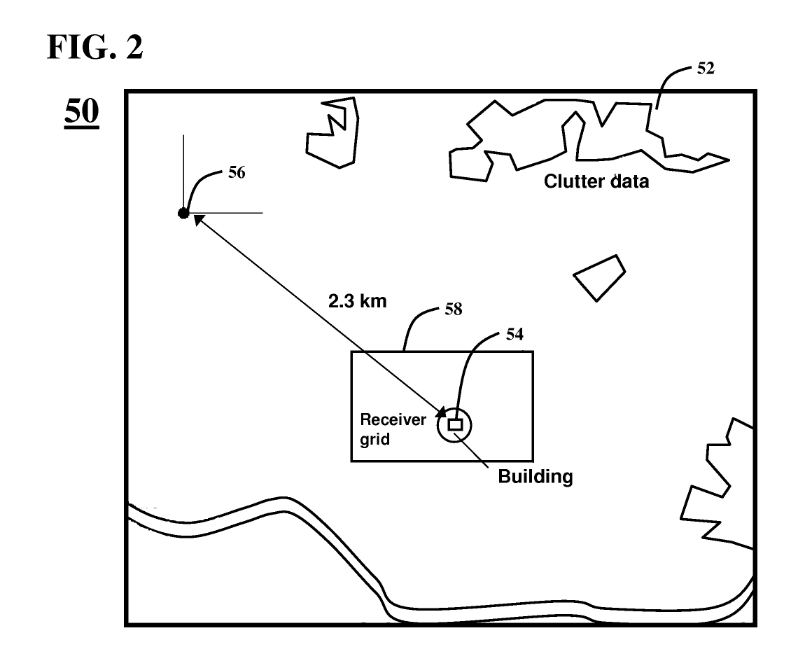

An example of such capability is shown in the representation 50 of FIG. 2. In this figure, an image of a high-resolution building 54 is superimposed on the low-resolution clutter data 52. An antenna 56 is shown as being 2.3 km away from the building 54. The receiver area 58 can consists of a rectangular mesh or grid of receivers spaced 5 m by 5 m apart.

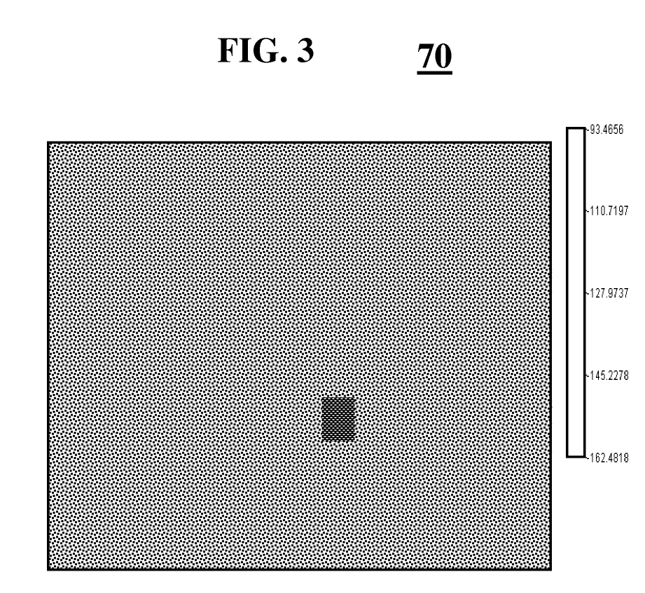

The plot shown in the image 70 of FIG. 3 is the resulting RF coverage for the receiver region. What is noteworthy is that the building object has been used to denote the receivers as belonging to the building object. As a result, the losses computed at the receiver are the empirical losses including building penetration losses having a mean value and standard deviation. This result extends the capability of the empirical engine to resolve penetration losses for high-resolution (3-D) objects if they are available. This capability will be unique to the MotoWavez software application and can be extended further by considering additional objects such as vehicles and foliage regions. Further note that although this application is designed for simulating radio frequency coverage, other ranges of electromagnetic waves can implement the techniques herein to provide coverage map simulations in other spectrum ranges outside of the radio frequency spectrum.

Embodiments herein can also exploit capabilities now offered through Google Earth by Google, Inc. of Mountain View, Calif. or other similar mapping functions. Although not readily apparent, useful data can be obtained for the computation of locations, losses, and object types forming such mapping functions. As already mentioned, low-resolution clutter data can be obtained for various regions due to the ubiquity of Motorola's NetPlan solution. However, it is also possible to generate low- and high-resolution data and appropriate databases useful for such simulations using Google Earth.

Google Earth Plus and advanced versions of Google Earth (Pro and Enterprise) provide features for creating outlines of objects as viewed by the Google Earth images. By enabling this feature, the user can generate polygons of buildings, vehicles, trees or entire regions by simply moving the mouse around the object and clicking to create the polygon. Multiple polygons can be saved to a single project and the project can be saved as a filename.kml file. The *.kml extension is essentially a text file with XML code. In that code, Google provides the coordinates of the vertices of each polygon in latitude and longitude. This data can be extracted to generate Universal Transverse Mercator (UTM) coordinates which are in meters and the regions or objects defined relative to any desired format. Software incorporating this feature can directly import Google *.kml files, generating either clutter regions or 3-D buildings. This capability can be used for other tools as only format conversions are involved.

Thus, a new method for improving the results of empirical computations for RF coverage simulations can comprise classifying receivers as either belonging to a certain object type, and if so, to implement penetration losses for that type of object at the receiver point. This technique improves the accuracy of the empirical computation while still providing the computational speed benefit when compared to more accurate simulation approaches. By using Google Earth Plus, it is also possible to generate low- and high-resolution data for computing empirical results using the approach described herein.

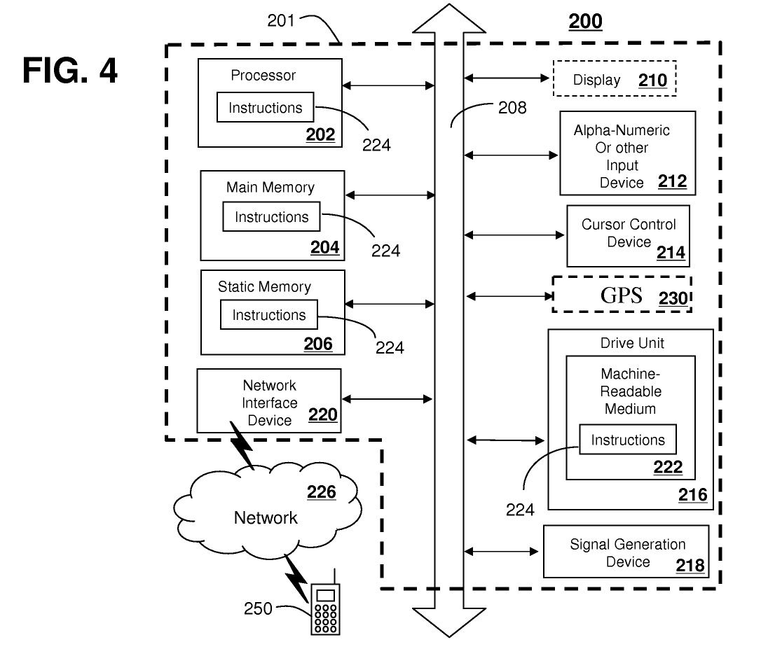

In another embodiment of the present invention as illustrated in the diagrammatic representation of FIG. 4, is a computer system 200 or electronic product 201 that can include a processor or controller 202 coupled to an optional display 210. The electronic product 201 can selectively be a wrist-worn device or a hand-held device or a fixed device. Generally, in various embodiments it can be thought of as a machine in the form of a computer system 200 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa. The computer system can further include a location finding device such as a GPS receiver 230.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication or presentations. Further, while a single machine is illustrated, the term “machine” shall also be taken to include any collection of machines that individually or jointly execute a set (or multiple sets) of instructions to perform any one or more of the methodologies discussed herein.

The computer system 200 can include a controller or processor 202 (e.g., a central processing unit (CPU), a graphics processing unit (GPU, or both), a main memory 204 and a static memory 206, which communicate with each other via a bus 208. The computer system 200 may further include a presentation device such the display 210. The computer system 200 may include an input device 212 (e.g., a keyboard, microphone, etc.), a cursor control device 214 (e.g., a mouse), a disk drive unit 216, a signal generation device 218 (e.g., a speaker or remote control that can also serve as a presentation device) and a network interface device 220. Of course, in the embodiments disclosed, many of these items are optional.

The disk drive unit 216 may include a machine-readable medium 222 on which is stored one or more sets of instructions (e.g., software 224) embodying any one or more of the methodologies or functions described herein, including those methods illustrated above. The instructions 224 may also reside, completely or at least partially, within the main memory 204, the static memory 206, and/or within the processor or controller 202 during execution thereof by the computer system 200. The main memory 204 and the processor or controller 202 also may constitute machine-readable media.

Dedicated hardware implementations including, but not limited to, application specific integrated circuits, programmable logic arrays, FPGAs and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device 220.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

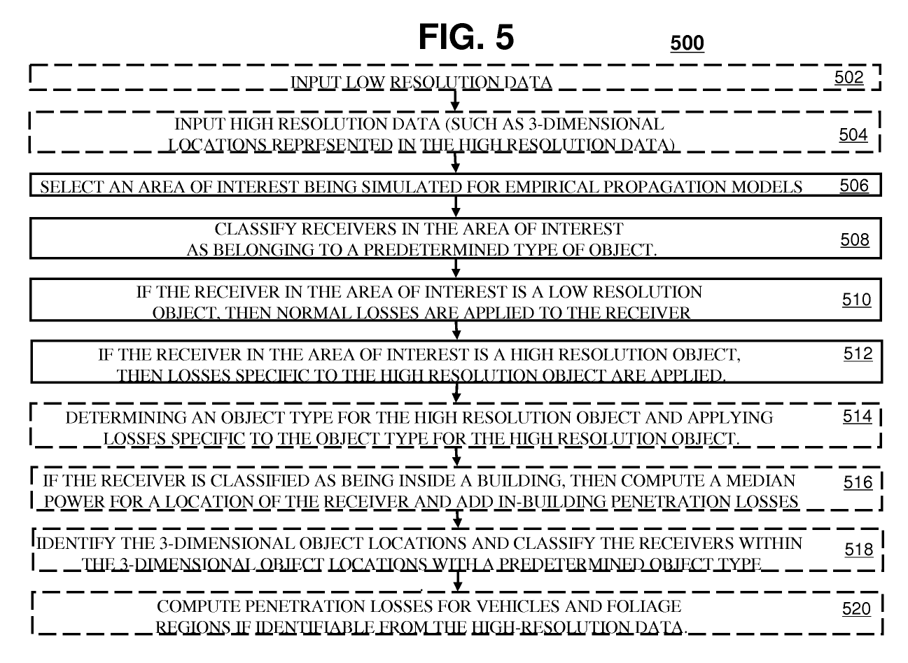

Referring to FIG. 5, a flow chart illustrating a method 500 to improve accuracy of empirical propagation models for radio frequency coverage simulations is shown. The flow chart illustrating method 500 in certain aspects can be considered a generic version of the method 10 in the flow chart of FIG. 1. The method 500 can include loading or inputting low resolution data and high resolution data at steps 502 and 504. The high resolution data can include 3-dimensional locations represented in the high resolution data. The method can further include the step 506 of selecting an area of interest being simulated for empirical propagation models and classifying receivers in the area of interest at step 508 as belonging to a predetermined type of object. If the receiver in the area of interest is a low resolution object, then normal losses are applied to the receiver at step 510 and if the receiver in the area of interest is a high resolution object, then losses specific to the high resolution object are applied at step 512. The method 500 can further include the step 514 of determining an object type for the high resolution object and then applying losses specific to the object type for the high resolution object. If the receiver in the area of interest is classified as being inside a building, then the method 500 can further compute a median power for a location of the receiver and add in-building penetration losses at step 516. The method can further include the step 518 of identifying the 3-dimensional object locations and classifying the receivers within the 3-dimensional object locations with a predetermined object type. A low-resolution object can correlate to an image of low-resolution clutter data and a high-resolution object can correlate to an image of a high-resolution building superimposed on the low-resolution clutter data. Additionally, the method 500 can further compute penetration losses for vehicles and foliage regions if identifiable from the high-resolution data at step 520.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of improving accuracy and computational efficiency by combining empirical and deterministic propagation methods for radio frequency coverage simulations using mixed resolution databases, comprising the steps of:
selecting an area of interest being simulated for empirical propagation models;
classifying receivers in the area of interest as belonging to a predetermined type of object;
if the receiver in the area of interest is a low resolution object, then apply normal losses to the receiver; and
if the receiver in the area of interest is a high resolution object, then apply losses specific to the high resolution object.

2. The method of claim 1, wherein the method further comprises the step of determining an object type for the high resolution object and then applying losses specific to the object type for the high resolution object.

3. The method of claim 2, wherein if the receiver in the area of interest is classified as being inside a building, then the method further comprises the step of computing a median power for a location of the receiver and adding in-building penetration losses.

4. The method of claim 2, wherein the method further comprises loading low-resolution data.

5. The method of claim 4, wherein the method further comprises the step of loading high-resolution data.

6. The method of claim 5, wherein the method further comprises the step of loading high-resolution data having 3-dimensional object locations represented in the high resolution data.

7. The method of claim 6, wherein the method further comprises the step of identifying the 3-dimensional object locations and classifying the receivers within the 3-dimensional object locations with a predetermined object type.

8. The method of claim 1, wherein the low-resolution object correlates to an image of low-resolution clutter data and the high-resolution object correlates to an image of a high-resolution building superimposed on the low-resolution clutter data and wherein the method is done in a sequential and adaptive manner using a single processor.

9. The method of claim 5, wherein the method further computes penetration losses for vehicles and foliage regions if identifiable from the high-resolution data.

10. A computer program embodied in a computer storage medium and operable in a data processing machine for improving accuracy of empirical propagation models for radio frequency coverage simulations, comprising instructions executable by the data processing machine, that cause the data processing machine to:
select an area of interest being simulated for empirical propagation models;
classify receivers in the area of interest as belonging to a predetermined type of object;
if the receiver in the area of interest is a low resolution object, then apply normal losses to the receiver; and
if the receiver in the area of interest is a high resolution object, then apply losses specific to the high resolution object.

11. The computer program of claim 10, wherein the instructions further cause the data processing machine to determine an object type for the high resolution object and then apply losses specific to the object type for the high resolution object.

12. The computer program of claim 11, wherein if the receiver in the area of interest is classified as being inside a building, then the instructions further cause the data processing machine to compute a median power for a location of the receiver and adding in-building penetration losses.

13. The computer program of claim 11, wherein the instructions further cause the data processing machine to load low-resolution data.

14. The computer program of claim 13, wherein the instructions further cause the data processing machine to load high-resolution data.

15. The computer program of claim 14, wherein the instructions further cause the data processing machine to load high-resolution data having 3-dimensional object locations represented in the high resolution data.

16. The computer program of claim 15, wherein the instructions further cause the data processing machine to identify the 3-dimensional object locations and classify the receivers within the 3-dimensional object locations with a predetermined object type.

17. The computer program of claim 10, wherein the low-resolution object correlates to an image of low-resolution clutter data and the high-resolution object correlates to an image of a high-resolution building superimposed on the low-resolution clutter data.

18. The computer program of claim 14, wherein the method further cause the data processing machine to compute penetration losses for vehicles and foliage regions if identifiable from the high-resolution data.

19. A system for simulating and improving accuracy of empirical propagation models for radio frequency coverage, comprising:
a display; and
a processor coupled to the display, operable to:
input low-resolution data and high-resolution data;
select an area of interest being simulated for empirical propagation models;
classify receivers in the area of interest as belonging to a predetermined type of object;
if a receiver in the area of interest is a low resolution object, then apply normal losses to the receiver;
if a receiver in the area of interest is a high resolution object, then apply losses specific to the high resolution object; and
if a receiver in the area of interest is classified as being inside a building, then further compute a median power for a location of the receiver and add in-building penetration losses.

20. The system of claim 19, wherein the high-resolution data has 3-dimensional object locations represented in the high resolution data, wherein the processor is further operable to identify the 3-dimensional object locations and classify the receivers within the 3-dimensional object locations with a predetermined object type.
